(19) United States
(12) Patent Application Publication
(10) Pub. No.: US 2024/0042732 A1
(43) Pub. Date: Feb. 8, 2024

(54) COMPOSITE MATERIALS AND METHODS FOR INHIBITING RODENT INGRESS

(71) Applicant: DelStar Technologies, Inc., Alpharetta, GA (US)

(72) Inventors: Rebecca Wilson, Stalybridge (GB); Geoffrey Henstock, Greater Manchester (GB)

(21) Appl. No.: 18/364,086

(22) Filed: Aug. 2, 2023

Related U.S. Application Data
(60) Provisional application No. 63/394,525, filed on Aug. 2, 2022.

(51) Int. Cl. B32B 15/085; B32B 15/02; B32B 7/12; B32B 7/06; B32B 27/32; B32B 9/04; B32B 9/02; B32B 27/28; C09J 7/28; A01M 29/30

(52) U.S. Cl. CPC B32B 15/085; B32B 15/02; B32B 7/12; B32B 7/06; B32B 27/32; B32B 9/041; B32B 9/02; B32B 27/283; C09J 7/28; A01M 29/30; B32B 2405/00; B32B 2260/021; B32B 2260/046; B32B 2307/748; C09J 2301/16; C09J 2400/163; C09J 2301/304; C09J 2423/041; C09J 2400/20; C09J 2483/00

(57) ABSTRACT

Composite materials are provided for sealing openings, gaps or holes in walls and other barriers. The composite materials are particularly useful for providing a durable seal across such holes to prevent rodent ingress therethrough. The composite material comprises a wire mesh layer, an adhesive and an outer protective layer. The wire mesh layer is resistant to rodent's chewing to thwart the rodent from chewing through the material. The protective layer provides an aesthetic outer layer that covers the sticky adhesive layer and provides a surface for handling the tape. The adhesive serves to both bond the protective layer to the wire mesh and to provide an opposing sticky surface for adhering the composite material to the target area on a wall, partition, door, roof, or other barrier.

### CROSS-REFERENCE TO RELATED APPLICATIONS

This application claims the benefit of U.S. Provisional Application Ser. No. 63/394,525, filed Aug. 2, 2022, the complete disclosure of which is incorporated herein by reference for all purposes.

### TECHNICAL FIELD

This description generally relates to composite materials and methods for sealing holes, gaps, cracks or openings in walls, partitions, doors, roofs, and other barriers and more particularly to pest control devices and methods for preventing the ingress of pests, such as rodents, through such barriers.

### BACKGROUND

Controlling pests, including rodents, is a continuing issue for many homes and businesses, especially commercial entities such as those involved in the food industry. This issue is particularly significant where pests, such as rodents or insects, are located, or travel, in hard to reach areas, making it difficult to set, retrieve and service traps.

Rodents generally move freely into and out of buildings through gaps, cracks or holes in walls or foundations. Holes in the walls, for example are an easy and common entry point for rats into a building. As buildings age and settle, even the tiniest of holes that form can be enough for a rat to enter inside.

Once these rodents gain access to a building, it can be very difficult to get rid of them with traps. Certain rodents, such as rats, are acutely aware of changes in their environment and will avoid new objects, such as traps. While poison may be more effective, it comes with downsides, such as safety concerns with children and other small animals, such as pets.

Thus, a more effective way of controlling rats is to prevent them from entering a building in the first place. This can, however, be challenging as rats are known for their ability to chew through most barriers. The muscles controlling a rat's jaws are very powerful. These pests will generally chew on anything that is not harder than their teeth, including wood, bricks, cinder blocks and softer forms of concrete and metal.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

In one aspect, a composite material or tape for sealing an opening is provided. The composite material includes a wire mesh layer having a first surface and a second surface opposite the first surface and an adhesive extending through the wire mesh layer from the first surface to the second surface. The composite material further includes a protective layer bonded to the adhesive at the second surface.

The composite material or tape is particularly useful for preventing rodent ingress through holes or gaps in walls or other barriers. The wire mesh layer is preferably constructed of a material that is resistant to rodent's chewing to thwart the rodent from chewing through the material. The protective layer provides an aesthetic outer layer that covers the sticky adhesive layer and provides a surface for handling the tape. The adhesive serves to both bond the protective layer to the wire mesh and to provide an opposing sticky surface for adhering the composite material to the target area on a wall, partition, door, roof, or other barrier.

In embodiments, the composite material may further include a release layer or liner removably coupled to the adhesive layer. The release liner covers and protects the adhesive layer until the user is ready to apply the material, upon which the release liner is removed leaving a sticky adhesive layer exposed and ready for application against a target area on a wall or other barrier.

The wire mesh layer may comprise a metal that is processed into a structure of interlocking loops and is strong enough to resist a rodent chewing their way through. Suitable materials for the wire mesh layer include copper and all alloys, stainless steel and all alloys, steels of all types, carbon steel, coated steel, super alloys, iron, titanium, galvanized steel, tungsten, zinc, nickel, aluminum and all alloys, or any combination of the above. In one embodiment, the wire mesh layer comprises stainless steel or a steel alloy.

In certain embodiments, the wire mesh layer is formed from a cylindrical wire mesh, such as a knitted sleeve or the like. The cylindrical wire mesh is cut along its longitudinal axis and then flattened to form a planar wire mesh layer. This provides the advantage that the planar mesh layer only has sharp edges along the cut edge.

In embodiments, the adhesive layer comprises a hotmelt adhesive. Suitable hotmelt adhesives include ethylene-vinyl acetate (EVA), ethylene-acrylate copolymers, polyolefins (PO), polybutene, amorphous polyolefin, polyamides, polyesters, polyurethanes, styrene block copolymers (SBC), polycaprolactone, polycarbonates, fluoropolymers, silicone rubbers, polypyrrole (PPY) and the like.

In an exemplary embodiment, the adhesive layer comprises a thermoplastic rubber, such as a styrene-butadiene-styrene (SBS) and/or a styrene-isoprene (SIS). The thermoplastic rubber may further include an antioxidant and/or a resin tackifying rosin, such as tackifying esters/rosins that may be aliphatic and/or aromatic from C5 to C9.

The protective layer may comprise any suitable material that bonds to and covers the wire mesh and prevents the adhesive from being exposed to the second surface of the wire mesh, such as a cotton, silicone, cellulose triacetate, cellulose and cellulosic polymers, and other woven and nonwoven fabrics.

In certain embodiments, the outer protective layer comprises a polymer material. Suitable polymers include acrylics, such as polyacrylic acids (PAA) or poly(methyl methacrylate) (PMMA), a polyethylene, such as ultra-high, high (HDPE), medium or low-density polyethylene (LDPE), PP of all types and all other olefins, polyamides, such as nylon, polylactic acid, polycarbonate, polyether sulfone, polyether ether ketone (PEEK), polyetherimide, polyethylene, polyphenylene oxide, polyphenylene sulfide, polypropylene, polystyrene, polyvinyl chloride (PVC) and all other vinyl derivatives, polyvinylidene fluoride (PVDF), polytetrafluoroethylene (Teflon), polyethylene terephthalate (polyester), polyamide, polystyrene and the like.

In one such embodiment, the protective layer comprises a low-density polyethylene (LDPE). In an exemplary embodiment, the protective layer comprises an LDPE film having a thickness of about 25 μm to about 150 μm, preferably between about 50 μm to about 100 μm and more preferably about 75 μm (thicknesses measured at a foot pressure of 50 Kpa).

In another aspect, a method for making a composite material or tape for sealing an opening comprises forming a planar wire mesh layer having a first surface and a second surface opposite the first surface. An adhesive is incorporated into the planar wire mesh layer from the first surface to the second surface and an outer protective layer is bonded to the adhesive at the second surface of the planar wire mesh.

In embodiments, the planar wire mesh is formed from a cylindrical wire mesh or sleeve. The cylindrical wire mesh is cut along its transverse axis and flattened to form the planar wire mesh.

The composite material may be formed by a variety of methods, such as gluing, chemical welding, heat welding, pressure welding and the like. In an exemplary embodiment, the wire mesh layer is provided between the protective layer and the adhesive layer and bonded through thermocompression at a temperature and pressure suitable for incorporating the adhesive throughout the wire mesh and bonding the protective layer to the adhesive.

In embodiments, a release layer or liner is removably coupled to the adhesive on the opposite side of the wire mesh from the protective layer. The release layer may be bonded through thermocompression at the same time as the other layers, or through other methods known by those in the art.

The recitation herein of desirable objects which are met by various embodiments of the present description is not meant to imply or suggest that any or all of these objects are present as essential features, either individually or collectively, in the most general embodiment of the present description or in any of its more specific embodiments.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Composite materials or tapes are provided for sealing openings, gaps or holes in walls and other barriers. The composite materials are particularly useful for providing a durable and robust seal across such holes to prevent rodent ingress therethrough.

The composite material generally includes a wire mesh layer having a first surface and a second surface opposite the first surface and an adhesive extending through the wire mesh layer from the first surface to the second surface. The composite material further includes a protective layer bonded to the adhesive at the second surface.

The wire mesh layer is preferably constructed of a material that is resistant to rodent's chewing to thwart the rodent from chewing through the material. The wire mesh may be fabricated from a variety of materials, such as metals, plastics, fibers, multi-filaments and the like, that are processed into a structure of interlocking loops. In certain embodiments, the wire mesh layer comprises a metal having a hardness in N/mm² that is preferably harder than a rodent's teeth. Suitable metals for the mesh include copper and all alloys, stainless steel and all alloys, steels of all types, carbon steel, coated steel, super alloys, iron, titanium, galvanized steel, tungsten, zinc, nickel, aluminum and all alloys, nickel or any combination of the above.

In a preferred embodiment, the wire mesh comprises stainless steel or an alloy of stainless steel. The steel may have a width of about 50 mm to about 150 mm, preferably about 75 mm to about 125 mm, and a thickness of about 0.1 mm to about 1 mm, preferably between about 0.4 to about 0.6 mm. In an exemplary embodiment, the width of the wire mesh is about 95 mm and the thickness is about 0.453 mm.

The wire mesh may comprise about 0.5 stiches per cm to about 15 stiches per cm, preferably about 5 to about 10 stiches per cm, and more preferably about 5 stitches per cm, and may be considered fine, medium-fine, standard, coarse or super-coarse. The wire mesh may be formed from crimping, calendaring, folding, layering and rolling processes.

In certain embodiments, the wire mesh may be pre-formed in a substantially cylindrical shape, such as a sock or sleeve. A suitable metallic sock is described in EP Patent No. 3231404 to Knitmesh Limited, the complete disclosure of which is incorporated herein by reference. The cylindrical wire mesh may be cut along its transverse axis to form a substantially planar shape. This provides a mesh layer without any sharp edges except along the cut edge.

The adhesive serves to both bond the protective layer to the wire mesh and to provide an opposing sticky surface for adhering the composite material to the target area on a wall, partition, door, roof, or other barrier. The adhesive layer may comprise any suitable adhesive. In certain embodiments, the adhesive layer comprises a hot-melt adhesive, or a form of thermoplastic adhesive that may include a base layer comprising ethylene-vinyl acetate (EVA), ethylene-acrylate copolymers, polyolefins (PO), polybutene, amorphous polyolefin, polyamides, polyesters, polyurethanes, styrene block copolymers (SBC), polycaprolactone, polycarbonates, fluoropolymers, silicone rubbers, polypyrrole (PPY) and the like.

The thermoplastic adhesive may include one or more additives, such as tackifiers, waxes, plasticizers, antioxidants, UV stabilizers, pigments, dyes, glitter, biocides, flame retardants, antistatic agents, fillers and the like.

In a preferred embodiment, the adhesive layer comprises a thermoplastic rubber, such as a thermoplastic rubber styrene-butadiene-styrene (TP-SBS) and/or thermoplastic rubber styrene-isoprene (TP-SIS). The thermoplastic rubber may further include an antioxidant and/or a resin tackifying rosin, such as tackifying esters/rosins that may be aliphatic and/or aromatic from C5 to C9.

The protective layer provides an aesthetic outer layer that covers the sticky adhesive layer and provides a surface for handling the tape. The outer protective layer may comprise any suitable material that bonds to and covers the wire mesh and prevents the adhesive from being exposed to the second surface of the wire mesh, such as a cotton, silicone, polymer, or metal sheet. In certain embodiments, the outer protective layer comprises a polymer material.

The polymer layer may include any suitable polymer that can be bonded with the metal mesh layer. In certain embodiments, the polymer layer comprises a thermoplastic material that becomes pliable or moldable at a certain elevated temperature and solidifies upon cooling. Suitable thermoplastic materials include acrylics, such as polyacrylic acids (PAA) or poly(methyl methacrylate) (PMMA), PP of all types and all other olefins, polyamides, such as nylon, polylactic acid, polycarbonate, polyether sulfone, polyether ether ketone (PEEK), polyetherimide, polyethylene, polyphenylene oxide, polyphenylene sulfide, polystyrene, polyvinyl chloride (PVC) and all other vinyl derivatives, polyvinylidene fluoride (PVDF), polytetrafluoroethylene (Teflon), polyethylene terephthalate (polyester).

In other embodiments, the protective layer may comprise other materials, such as cellulose triacetate, cellulose and cellulosic polymers, cotton and other woven and nonwoven fabrics.

In one embodiment, the protective layer comprises a polyethylene, such as ultra-high, high, medium or low-density polyethylene (LDPE). In an exemplary embodiment, the protective layer comprises an LDPE film having a thickness between about 25 μm to about 150 μm, preferably between about 50 μm to about 100 μm and more preferably about 75 μm.

Methods area also provided for manufacturing the composites described herein. In one such method, the planar wire mesh is first manufactured from a cylindrical mesh sleeve as described above. The protective outer layer is positioned on one surface of the wire mesh and the adhesive is positioned on an opposite surface of the wire mesh. The three layers are compressed together at a suitable pressure to bond the adhesive throughout the wire mesh (i.e., from the first surface to the second surface) and to bond the protective outer layer to the wire mesh via the adhesive. In certain embodiments, the pressure is about 50 psi.

Once the three layers are suitably bonded to each other, a release liner or layer may be applied to the adhesive layer (opposite the protective layer). The release liner can be used to help handle the composite and to protect the sticky adhesive layer from the environment. Upon application of the composite, the release liner is removed and the adhesive surface is applied to the target area such that the wire mesh layer completely covers the hole or gap in the barrier and the outer protective layer is facing the user. This provides a relatively fast and easy method of applying the composite to any such hole in a wall or other barrier. The hotmelt adhesive readily sticks to walls or other barriers to provide a durable and robust seal across the hole that will thwart rodent ingress through the hole.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a composite material comprising a wire mesh layer having a first surface and a second surface opposite the first surface, an adhesive extending through the wire mesh layer from the first surface to the second surface and a protective layer bonded to the adhesive at the second surface.

A second embodiment is the first embodiment, wherein the adhesive layer is configured to bond the first surface of the wire mesh layer to a separate surface.

A 3^{rd} embodiment is any combination of the first 2 embodiments, further comprising a release layer removably coupled to the adhesive layer.

A 4^{th} embodiment is any combination of the first 3 embodiments, wherein the wire mesh layer comprises a metal.

A 5^{th} embodiment is any combination of the first 4 embodiments, wherein the wire mesh layer is formed from a cylindrical wire mesh.

A 6^{th}embodiment is any combination of the first 5 embodiments, wherein the cylindrical wire mesh comprises a knitted sleeve.

A 7^{th} embodiment is any combination of the first 6 embodiments, wherein the cylindrical wire mesh is cut along a transverse axis to form a planar wire mesh layer.

An 8^{th} embodiment is any combination of the first 7 embodiments, wherein the adhesive layer comprises a hotmelt adhesive.

A 9^{th} embodiment is any combination of the first 8 embodiments, wherein the hotmelt adhesive comprises a thermoplastic rubber.

A 10^{th} embodiment is any combination of the first 9 embodiments, wherein the hotmelt adhesive comprises an additive.

An 11^{th} embodiment is any combination of the first 10 embodiments, wherein the additive comprises an antioxidant or a tackifying resin.

A 12^{th} embodiment is any combination of the first 11 embodiments, wherein the polymer layer comprises a thermoplastic material.

A 13^{th} embodiment is any combination of the first 12 embodiments, wherein the polymer layer comprises low density polyethylene (LDPE).

In a second aspect, a composite material for use in sealing an opening is provide comprising any combination of the first 13 embodiments.

In a third aspect, a tape is provided comprising any combination of the first 13 embodiments.

In a 4^{th} aspect, a first embodiment is a tape for inhibiting rodent ingress through an opening, the tape comprising a wire mesh layer having a first surface and a second surface opposite the first surface, an adhesive layer bonded to the first surface and an outer protective layer bonded to the second surface.

A second embodiment is the first embodiment, wherein the wire mesh layer is formed from a cylindrical wire mesh.

A 3^{rd} embodiment is any combination of the first 2 embodiments, wherein the cylindrical wire mesh comprises a knitted sleeve.

A 4^{th} embodiment is any combination of the first 3 embodiments, wherein the cylindrical wire mesh is cut along a transverse axis to form a planar wire mesh layer.

A 5^{th} embodiment is any combination of the first 4 embodiments, wherein the adhesive layer comprises a hotmelt adhesive.

A 6^{th} embodiment is any combination of the first 5 embodiments, wherein the outer protective layer comprises a polymer.

A 7^{th} embodiment is any combination of the first 6 embodiments, wherein the outer protective layer comprises cotton.

An 8^{th} embodiment is any combination of the first 7 embodiments, wherein the outer protective layer comprises silicone.

In a 5^{th} aspect, a first embodiment is a method for making a composite material for sealing an opening. The method comprises forming a planar wire mesh layer having a first surface and a second surface opposite the first surface, incorporating an adhesive into the planar wire mesh layer from the first surface to the second surface and bonding an outer protective layer to the second surface of the planar wire mesh.

A second embodiment is the first embodiment, further comprising providing a cylindrical wire mesh and cutting the cylindrical wire mesh to form the planar wire mesh layer.

A 3^{rd} embodiment is any combination of the first 2 embodiments, wherein the cylindrical wire mesh is cut along a transverse axis.

A 4^{th} embodiment is any combination of the first 3 embodiments, further comprising pressing the planar wire mesh layer, the adhesive and the outer protective layer together to form the composite material.

A 5^{th} embodiment is any combination of the first 4 embodiments, further comprising removably bonding a release liner to the adhesive at the first surface.

A 6^{th} embodiment is any combination of the first 5 embodiments, wherein the wire mesh layer comprises a metal.

A 7^{th} embodiment is any combination of the first 6 embodiments, wherein the adhesive layer comprises a hotmelt adhesive.

An 8^{th} embodiment is any combination of the first 7 embodiments, wherein the hotmelt adhesive comprises a thermoplastic rubber.

A 9^{th} embodiment is any combination of the first 8 embodiments, wherein the hotmelt adhesive comprises an additive.

A 10^{th} embodiment is any combination of the first 9 embodiments, wherein the additive comprises an antioxidant or a tackifying resin.

An 11^{th} embodiment is any combination of the first 10 embodiments, wherein the protective layer comprises a thermoplastic material.

A 12^{th} embodiment is any combination of the first 11 embodiments, wherein the protective layer comprises low density polyethylene (LDPE).

In a sixth aspect, a tape is provided produced from any combination of the first 11 embodiments.

What is claimed is:

1. A composite material comprising:
a wire mesh layer having a first surface and a second surface opposite the first surface;
an adhesive extending through the wire mesh layer from the first surface to the second surface; and
a protective layer bonded to the adhesive at the second surface.

2. The composite material of claim 1, wherein the adhesive layer is configured to bond the first surface of the wire mesh layer to a separate surface.

3. The composite material of claim 1, further comprising a release layer removably coupled to the adhesive layer.

4. The composite material of claim 1, wherein the wire mesh layer comprises a metal.

5. The composite material of claim 1, wherein the wire mesh layer is formed from a cylindrical wire mesh.

6. The composite material of claim 3, wherein the cylindrical wire mesh comprises a knitted sleeve.

7. The composite material of claim 3, wherein the cylindrical wire mesh is cut along a transverse axis to form a planar wire mesh layer.

8. The composite material of claim 1, wherein the adhesive layer comprises a hotmelt adhesive.

9. The composite material of claim 8, wherein the hotmelt adhesive comprises a thermoplastic rubber.

10. The composite material of claim 8, wherein the hotmelt adhesive comprises an additive.

11. The composite material of claim 10, wherein the additive comprises an antioxidant or a tackifying resin.

12. The composite material of claim 1, wherein the polymer layer comprises a thermoplastic material.

13. The composite material of claim 1, wherein the polymer layer comprises low density polyethylene (LDPE).

14. A tape comprising the composite material of claim 1.

15. A tape for inhibiting rodent ingress through an opening, the tape comprising:
a wire mesh layer having a first surface and a second surface opposite the first surface;
an adhesive layer bonded to the first surface; and
an outer protective layer bonded to the second surface.

16. The tape of claim 15, wherein the wire mesh layer is formed from a cylindrical wire mesh.

17. The tape of claim 15, wherein the cylindrical wire mesh comprises a knitted sleeve.

18. The tape of claim 15, wherein the cylindrical wire mesh is cut along a transverse axis to form a planar wire mesh layer.

19. The tape of claim 15, wherein the adhesive layer comprises a hotmelt adhesive.

20. The tape of claim 15, wherein the outer protective layer comprises a polymer.

21. The tape of claim 15, wherein the outer protective layer comprises cotton.

22. The tape of claim 15, wherein the outer protective layer comprises silicone.
